(19) United States
(12) Patent Application Publication
(10) Pub. No.: US 2023/0275279 A1
(43) Pub. Date: Aug. 31, 2023

(54) REMANUFACTURING OF A BATTERY CELL

(71) Applicant: Cummins Inc., Columbus, IN (US)

(72) Inventors: Chung-Hsuan Huang, Columbus, IN (US); Corey W. Trobaugh, Columbus, IN (US); Ruigang Zhang, Columbus, IN (US)

(21) Appl. No.: 18/017,031

(22) PCT Filed: Jul. 20, 2021
(86) PCT No.: PCT/IB2021/056529

§ 371 Date: Jan. 19, 2023

Related U.S. Application Data
(60) Provisional application No. 63/059,329, filed on Jul. 31, 2020.

(51) Int. Cl. H01M 10/54; H01M 10/0525; H01M 4/04

(52) U.S. Cl. CPC H01M 10/54; H01M 10/0525; H01M 4/0459; H01M 2004/028

(57) ABSTRACT

A method of manufacturing a battery cell is disclosed. The method comprises recovering a cathode module from a used battery cell, assembling a new battery cell using the recovered cathode module. The used battery cell may be from a battery pack which has failed or reached end-of-life. The new battery cell may comprise a new anode module, a new electrolyte and/or a new separator. This may allow a battery cell to be manufactured in a manner which is more cost effective and environmentally sustainable than prior techniques.

### CROSS-REFERENCE TO RELATED APPLICATIONS

The present application claims priority to International Application Number PCT/IB2021/056529, entitled “REMANUFACTURING OF A BATTERY CELL,” filed on Jul. 20, 2021, which claims priority to U.S. Provisional Application Ser. No. 63/059,329, entitled “REMANUFACTURING OF A BATTERY CELL,” filed on Jul. 31, 2020, the entire disclosures of which are expressly incorporated herein by reference.

The present invention relates to techniques for remanufacturing of a battery cell, and in particular a Lithium ion battery cell. The present invention has particular, but not exclusive, application with battery cells used in battery packs for use in traction applications such as electric or hybrid electric vehicles, construction equipment, and so forth.

### BACKGROUND

Electric vehicles and hybrid electric vehicles, such as cars, buses, vans and trucks, use battery packs that are designed with a high ampere-hour capacity in order to give power over sustained periods of time. A battery pack comprises a large number of individual electrochemical cells connected in series and parallel to achieve the total voltage and current requirements. Typically, Lithium ion (Li-ion) battery cells are used as they provide a relatively good cycle life and energy density.

Battery packs for electric vehicle applications tend to degrade during use due to the arduous duty cycles that are usually encountered. When the battery packs no longer meet electric vehicle performance standards they may need to be replaced.

One of the challenges facing manufacturers of Lithium ion battery packs is ensuring the long-term sustainability of the materials used to make the battery cells. Another challenge is how to process end of life Lithium ion cells in an environmentally sustainable manner. A further challenge is the cost of ownership associated with battery packs using Lithium ion battery cells. Typically, the cost of a battery pack in an electric vehicle can be 50% or more of the total cost of the vehicle. This has to date limited the widespread adoption of electric and hybrid vehicles.

Processes for recycling end of life Lithium ion battery cells have therefore been explored in order to address the above issues.

Known Lithium ion battery cell recycling techniques tend to use mechanical, hydrometallurgical and/or pyrometallurgical processes to tear down the used battery cell and extract the reusable used materials from the cathode and other cell components. Multiple steps using hazardous chemicals and/or extreme conditions are usually employed. At the end of the process, raw powders and elemental metals are produced, which require further processing. The extracted materials may serve as the raw materials for the manufacture of a new battery cell.

A problem with known battery recycling techniques is that they tend to be complex, energy intensive and/or require significant quantities of strong acids and solvents, all of which may have an environmental impact and add to the cost of the recycling process.

It would therefore be desirable to provide techniques for recycling used battery cells which can reduce the cost and environmental impact of the recycling process.

### SUMMARY

According to one aspect of the present invention there is provided a method of manufacturing a battery cell, the method comprising:
recovering a cathode module from a used battery cell; and
assembling a new battery cell using the recovered cathode module.

The present invention may provide the advantage that, by recovering a cathode module from a used battery cell, and assembling a new battery cell using the recovered cathode module, it may be possible to manufacture a battery cell in a manner which is more cost effective and environmentally sustainable than prior techniques. Providing an effective remanufacturing process can also help to reduce the overall cost of ownership associated with battery packs.

Previous recycling techniques have typically used destructive processes to collect the used cathode active materials. For example, previous techniques include crushing and/or shredding the used battery, then leaching active materials from cathode electrodes and collecting the leached cathode active materials for re-use. This may involve multiple steps where hazardous chemicals and/or extreme conditions are employed and at the end of the process, raw powders and elemental metals are produced, which require further processing. On the other hand, in embodiments of the present invention, the whole of the recovered cathode module is used in the new battery cell. This may help to reduce the amount of processing required, reduce the overall energy expenditure, reduce the use of hazardous chemicals, reduce the use of water, reduce the need for new raw materials, reduce CO2 emissions, and/or reduce the cost of the recycling process.

The used battery cell may be, for example, from a battery pack which has failed or reached end-of-life. For example, the battery cell or battery pack may have reached 90%, 85% or 80% of full capacity, or any other appropriate value. As one example, the used battery cell may be from a battery pack which has been used in a traction application, and which has failed or reached end of life in that application.

It has been found that end-of-life or failure of a Lithium ion battery cell is frequently caused by degradation of the anode electrode. Typically, the active material in the anode electrode is graphite, which is relatively low cost, and which does not have a significant environmental impact. Therefore, in a preferred embodiment, the new battery cell comprises the recovered cathode module and a new anode module. Preferably the new anode module is newly manufactured from raw materials. The new anode module may comprise an active layer on a current collector. The active layer may comprise carbon (graphite). The current collector may comprise copper. A passivating layer may be provided on the active layer to ensure its stability. However, other types of anode module using other materials could be used instead. For example, rather than using a graphite based anode, a Silicon based anode, a Lithium titanate based anode or any other suitable type of anode could be used.

In alternative embodiments, rather than using a new anode module, some or all of the anode module could be recovered from a used battery cell or could comprise at least some recycled components.

Preferably the new battery cell further comprises a new (newly-manufactured) electrolyte. The new electrolyte may be, for example, a Lithium salt in an organic solvent. Typically, such electrolytes are relatively low cost and have a relatively low environmental impact, compared to at least some other components of a battery cell. Thus, use of a new electrolyte may help to ensure that the new battery cell has sufficient capacity in a reasonably cost effective and environmentally friendly manner. However, if desired, the new battery cell may comprise an electrolyte which is at least partially recovered or recycled.

Preferably the new battery cell further comprises a new (newly-manufactured) separator. The new separator may be a porous separator which provides ion diffusion channels in the battery cell. For example, the separator may comprise a microporous layer consisting of either a polymeric membrane or a non-woven fabric mat. Alternatively, the separator may be a “ceramic” separator comprising a porous mat made of ultrafine inorganic particles bonded using a small amount of binder or a conventional separator material coated with a thin layer of inorganic material. However, other materials may be used as well or instead.

Typically, the separator is relatively low cost and has a relatively low environmental impact, compared to at least some other components of a battery cell. Thus, use of a new separator may help to ensure that the new battery cell has sufficient capacity in a reasonably cost effective and environmentally friendly manner. However, if desired, the new battery cell may comprise a separator which is at least partially recovered or recycled.

Preferably the recovered cathode module comprises an active material and a current collector. The active material may be provided as an active layer on the current collector. The active material is preferably arranged to be oxidised during charging of the battery cell and reduced during discharge. In one embodiment, the active material comprises a Lithium metal oxide or phosphate. For example, the active material may comprise Lithium-Nickel-Manganese-Cobalt-Oxide (LiNiMnCoO2). However, other active materials, such as Lithium-Cobalt-Oxide, Lithium-Cobalt-Aluminium-Oxide, Lithium-Iron-Phosphate, Lithium-Manganese-Oxide-Spinel, Lithium-Nickel-Cobalt-Manganese-Oxide, Lithium-Titanate-Oxide, or any other suitable active material could be used instead.

Preferably the current collector acts as a substrate for the active material and provides a path for current flow to or from the battery cell. The current collector may comprise aluminium, or any other suitable material.

In a preferred embodiment, the battery cell is a Lithium-ion battery cell. However, the techniques described herein may be applied to any other suitable types of battery cell.

It has been found that, when a Lithium ion battery cell reaches end-of-life, there may still be remaining capacity in the cathode. This is because end-of-life of the cell may be due primarily to anode degradation rather than cathode degradation. However, the used cathode may still suffer from decreased capacity. This may be at least partially attributable to the consumption of Lithium ions in the first life.

In a preferred embodiment of the invention, the method further comprises performing a lithiation process on at least one of the recovered cathode module and an anode module prior to assembling the new battery cell.

For example, in one embodiment, a re-lithiation process is performed on the recovered cathode module prior to assembling the new battery cell. It has been found that this may allow a new battery cell with a recovered cathode module to have a capacity comparable with that of a battery cell with a new cathode module.

The re-lithiation process may be an electrochemical process. During the electrochemical re-lithiation process, the recovered cathode module may be used as an electrode. For example, the re-lithiation process may be performed using a full cell in which the recovered cathode module is used as a negative electrode, and in which the full cell further comprises a positive electrode comprising Lithium. This may allow Lithium ions to be intercalated into the active layer of the cathode module, thereby at least partially replacing ions lost during the first life. Thus, this may allow the capacity of the recovered cathode module to be at least partially restored.

Alternatively or in addition, a pre-lithiation process may be performed on an anode module. The pre-lithiation process may be performed on a new anode module, which may be newly manufactured from raw materials. The new battery cell may be assembled using the recovered cathode module and a pre-lithiated anode module.

The pre-lithiation process may be an electrochemical process. The pre-lithiation process may be performed using a full cell in which the anode module is used as a negative electrode, and in which the full cell further comprises a positive electrode comprising Lithium. This may allow Lithium ions to be intercalated into the active layer of the anode module. When the anode module is used in a new battery cell together with the recovered cathode module, this may allow at least some of the ions lost from the cathode module during first life to be replaced. Thus, this may allow the capacity of the recovered cathode module to be at least partially restored.

Alternatively or in addition to the above techniques, the lithiation process may comprise chemical immersion with a Lithium electrolyte.

The method may further comprise disassembling the used battery cell prior to recovery of the used cathode module. Parts such as a used anode module, used electrolyte, used separator and/or used container may be discarded or recycled.

The method may further comprise packing the new battery cell in a container. The container may be, for example, a cylindrical case, a prismatic case, a pouch, or any other suitable type of container for containing a battery cell. The container may be new, refurbished and/or made from recycled components. The container may be sealed to exclude moisture from the battery cell. The container may contain a single anode module and a single cathode module, or a plurality of anode modules and/or cathode modules, and an electrolyte. A separator may be provided between the or each anode module and cathode module.

The method may further comprise assembling a battery module and/or a battery pack using the assembled battery cell. The assembled battery module and/or battery pack may be used in any appropriate application, such as a traction application and a stationary application such as power generation.

According to another aspect of the invention there is provided a battery cell comprising:
a cathode module recovered from a used battery cell;
a new anode module; and
new electrolyte.

The battery cell may further comprise a new separator. The cathode module may be re-lithiated. The battery cell may be packaged in a container. The container may be, for example, a pouch, a cylindrical case or a prismatic case.

Features of one aspect of the invention may be used with any other aspect. Any of the method features may be provided as apparatus features and vice versa.

### BRIEF DESCRIPTION OF THE DRAWINGS

Preferred features of the present invention will now be described, purely by way of example, with reference to the accompanying drawings, in which:

FIG. 1 shows schematically parts of a Lithium ion battery cell;

FIG. 2 shows a closed-loop Lithium ion battery cell recycling process;

FIG. 3 shows a breakdown of the costs of the materials for a typical Lithium ion battery cell;

FIG. 4 shows a process of remanufacturing a Lithium ion battery cell in an embodiment of the invention;

FIG. 5 illustrates schematically the process of constructing a new Lithium ion cell;

FIG. 6 shows steps carried out in a process of re-lithiating a cathode module;

FIG. 7 illustrates an electrochemical re-lithiation process;

FIG. 8 shows a test matrix of tests carried out on remanufactured battery cells;

FIG. 9 is a plot of discharge capacity against cycle number for a Lithium ion cell;

FIG. 10 shows plots of discharge capacity against cycle number for the full cells with re-lithiated cathode modules;

FIG. 11 shows parts of a battery cell in an embodiment of the invention; and

FIG. 12 shows parts of a battery cell in another embodiment of the invention.

### DETAILED DESCRIPTION

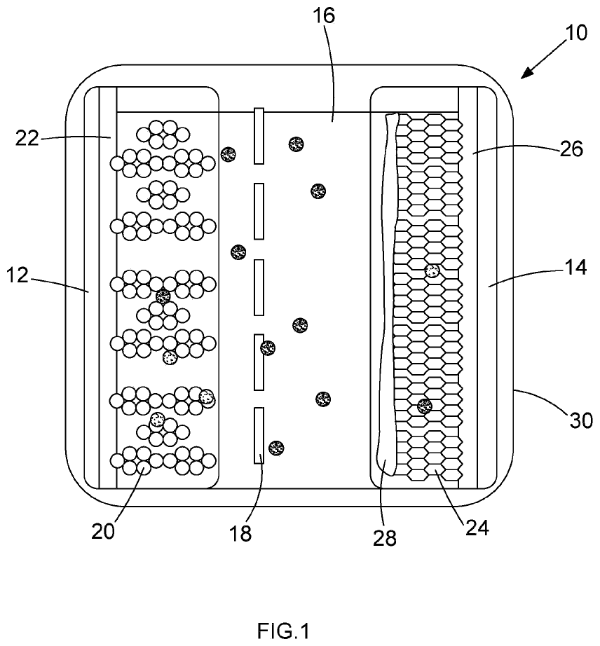

FIG. 1 shows schematically parts of a Lithium ion battery cell. Referring to FIG. 1, the battery cell 10 comprises cathode module 12, anode module 14, electrolyte 16 and separator 18. The cathode module 12 comprises an active layer 20 on a cathode current collector 22. The active layer is typically a Lithium metal oxide such as Lithium Cobalt Oxide (LiCoO2) or Lithium Nickel Cobalt Manganese Oxide (LiNixCoyMnzO2). The cathode current collector 22 is typically aluminium. The anode module 14 comprises a carbon (graphite) layer 24 on an anode current collector 26 which is typically copper. A passivating layer 28 is provided on the carbon layer 26 to ensure its stability. The electrolyte 16 is typically a Lithium salt in an organic solvent. The porous separator 18 keeps the cathode module 12 and the anode module 14 physically apart to prevent a short circuit but provides ion diffusion channels between the two. The battery cell 10 is typically packaged in a container 30 such as a cylindrical case, a prismatic case or a pouch.

When a battery cell reaches its end of life it needs to be replaced. The used battery cell may be recycled in order to reduce overall costs and the impact on the environment. At present, there are two major strategies for recycling of Li-ion batteries: open-loop and closed-loop. In an open-loop scenario, the materials recovered from the used battery packs are reused in any other (new) application. In a closed-loop scenario, the recovered materials are reincorporated directly into a new Li-ion battery. Both strategies are primary focused on collecting active materials such as Lithium, Cobalt, Nickel, etc from the cathode and other high value metals materials such as Aluminium, Copper, Iron, etc. from other parts of the battery.

Existing recovery technologies typically utilize three major process: hydrometallurgical, pyrometallurgical and intermediate and direct physical processes.

Hydrometallurgical processes start with the deconstruction of the battery pack into battery cells. The cells are discharged and then physically separated into subcomponents (cathode, anode, casing, etc). Once the cell has been physically separated, the plastic and/or metal case is directly recycled. The graphite on anode is extracted and recycled or otherwise disposed of. The copper anode substrate is collected. The cathode with major active materials, such as Lithium and Cobalt is physically crushed and soaked in a functional solvent such as N-Methyl-2-Pyrrolidone (NMP) to remove the active material from the aluminium substrate. The recovered aluminium material is recycled at this stage. The collected and filtered active cathode material is then calcination at a high temperature (around 700° C.) followed by additional grinding process. The fine collected material is extracted via a chemical leaching process often with strong acid solvent such as Sulfuric acid (H2SO4). This process uses significant amount of strong acid and solvents, which will require further processing.

Pyrometallurgical processes involve preheating the battery cell to evaporate the electrolyte and a pyrolyzing process to pyrolyze (burn out) the plastic components. This is followed by a smelting process at extremely high temperature (around 1400° C.) to convert all the active metal materials such as Copper, Cobalt, Nickel, Iron, Lithium etc. into slag. The recovered metals turn into alloy from the smelting process. Copper, Iron and active materials such as Nickel, Cobalt and Lithium are recovered by a further leaching process, solvent (such as Hydrochloric acid) extraction, oxidation, and a firing process. This approach is very energy intensive.

An intermediate physical process has also been proposed. This process requires mechanically shredding and hammermilling the used battery cell and filtering out/collecting the active lithium oxide metals. The process requires a soda ash (Na2CO4) solution to recover Li2CO3 which produces waste water. The direct physical recycling process recovers the active materials. The recovered materials are reapplied directly into the Lithium ion battery supply chain. The process first utilizes CO2 at above supercritical condition to extract electrolyte from the used battery cell. The battery cell then undergoes physical separation to collect the Aluminium, Copper, Iron and graphite anode, and the plastic etc. The recovered cathode active materials are reapplied direct to the Li-ion battery manufacturing process.

Thus, the conventional Li-ion battery cell recycling processes utilize mechanical, hydrometallurgical, and pyrometallurgical or a combination of these processes to tear down the used battery cell and extract the reusable used materials from cathode and other cell components. These processes involve multiple steps where hazardous chemicals and/or extreme conditions are employed. At the end of the process, raw powders and elemental metals are produced, which require further processing.

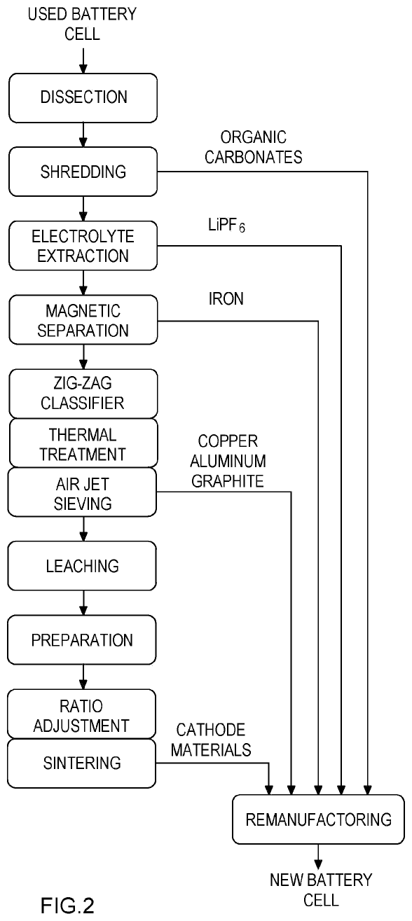

FIG. 2 shows an overview of a typical closed loop Lithium ion battery cell recycling process.

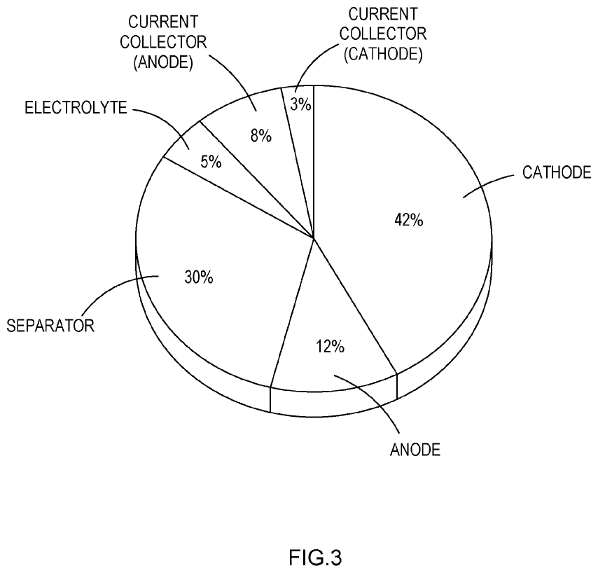

In the current recycling process, the extracted Lithium/Nickel/Manganese/Cobalt oxide materials serve as the raw materials for the new cathode remanufacture. The cathode and the expensive elements of Lithium, Nickel, Manganese and Cobalt are the primary focus due to the materials substantiality/availability and the value of those elements. FIG. 3 shows a breakdown of the cost of the materials for a typical Li-ion battery cell.

It has been found that the cell degradation of a Lithium Nickel Manganese Cobalt oxide (NMC) type of Lithium Ion Battery is due primarily to anode (Graphite electrode) degradation. This may involve: (a) graphite exfoliation due to repeated charging and discharging, fast charging, and environmental temperature; (b) formation of a solid electrolyte interface (SEI) that prevents efficient electron transfer; (c) electrode materials binder degradation; and/or (d) Lithium plating and dendrite.

Compared to the anode, degradation of the NMC cathode has minimal impact on the life of the NMC battery cell in electric vehicle applications. Moreover, from a battery recycling perspective, anode materials (graphite) are relatively low cost and more environmentally friendly.

Embodiments of the present invention propose a simple, cost-effective and less hazardous remanufacturing process that re-lithiates a used cathode module and recombines the refurbished cathode module with fresh anode material to recreate a battery cell with near specification capacity.

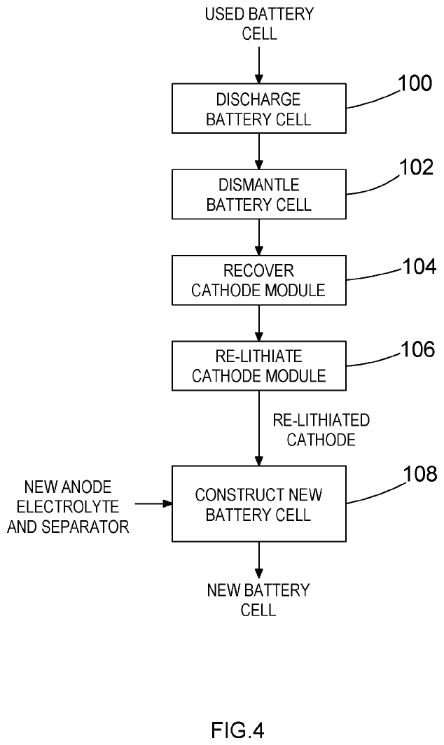

FIG. 4 is a flow chart showing the overall process of remanufacturing a Lithium ion battery cell in an embodiment of the invention. Referring to FIG. 4, in step 100 the used Lithium ion cell is first fully discharged. In step 102 the fully discharged cell is dismantled into its component parts, including the cathode module, the anode module, the separator, the electrolyte, and any other parts. In step 104 the cathode module is recovered from the dismantled battery cell. The other components may be broken down and recycled or otherwise disposed of. In step 106 the recovered cathode module undergoes a re-lithiation process to back fill the lost Lithium ions, as will be explained below. Then, in step 108 a new Lithium ion battery cell is constructed using the re-lithiated cathode module together with a new anode module, a new separator, and new electrolyte.

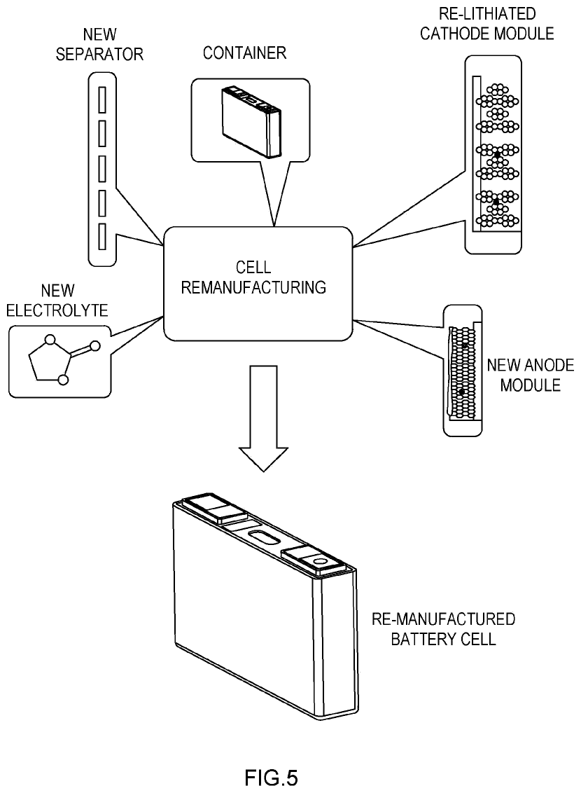

FIG. 5 illustrates schematically the process of constructing a new Lithium ion cell. The recovered cathode module, new anode module, new separator, and new electrolyte are packaged into a container such as a cylindrical case, a prismatic case or a pouch to produce a new (re-manufactured) Lithium ion cell. The new anode module, new separator and new electrolyte are manufactured from raw materials, which may include at least some recycled materials. The container may be new or refurbished.

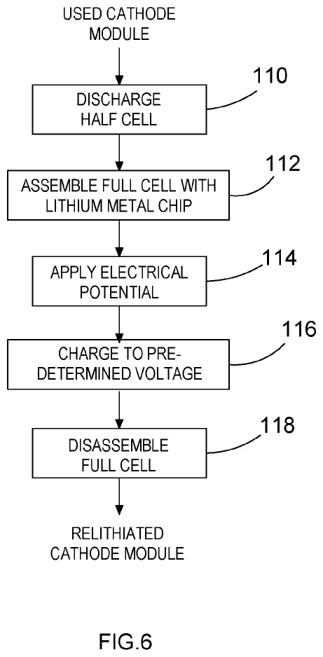

Prior to constructing the new cell, the recovered cathode undergoes a re-lithiation process to back fill the Lithium ions lost from the first life. FIG. 6 shows the steps carried out in a re-lithiation process in one embodiment. Referring to FIG. 6, in step 110 the used cathode module is first discharged to a predetermined half-cell voltage, which may be for example 2V. In step 112, the discharged cathode module is assembled into a new full cell with a separator, an organic electrolyte and lithium metal chip as a lithium ion source. In step 114 the newly constructed full cell is connected to an electrical potential. In step 116 the full cell is charged at a designated charging (C) rate to a predetermined voltage (for example, around 4V). This causes the used cathode module to undergo an electrochemical re-lithiation process. After the used cathode module has been fully charged with lithium ions, in step 118 the re-lithiated cathode module is dissembled from the full cell and is ready to be incorporated into a new Lithium ion cell in the manner described above.

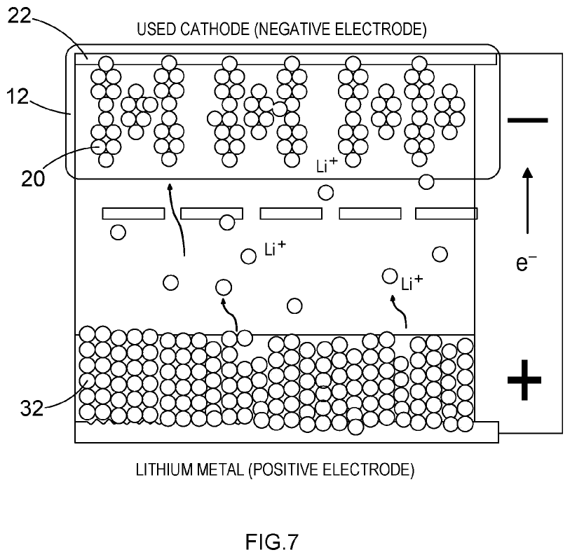

The electrochemical re-lithiation process is illustrated in FIG. 7. In this process, the used cathode module 12 is used as a negative electrode (“anode”) and the Lithium metal chip as a positive electrode (“cathode”). When an electrical potential is applied to the full cell, Lithium ions migrate from the Lithium metal chip 32 to the “anode” which here is the used cathode module 12. During this process, the Lithium ions are intercalated into the active layer 20 of the cathode module.

In an alternative approach, the cathode module could be re-lithiated via chemical immersion with a Lithium organic electrolyte.

In one embodiment, the used (degraded) battery cell is a Lithium-Nickel-Manganese-Cobalt-Oxide (NMC) cell. The whole used cathode module is extracted, and a re-lithiation process is applied to distribute fresh lithium ions. A refurbished (NMC) Lithium ion battery cell is then built with a new anode, separator, and electrolyte.

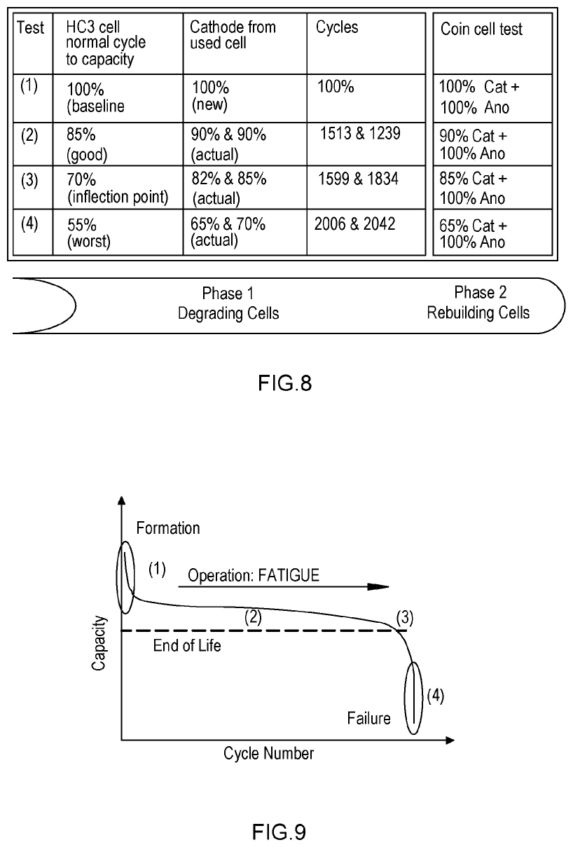

In order to demonstrate the viability of the proposed techniques, tests were carried out on remanufactured battery cells using recovered cathodes from degraded Li-ion cells. The test matrix is shown in FIG. 8.

In phase one of the test, battery cells were degraded at a C-rate of 1 in controlled room temperature conditions to three different levels. The three levels represent batteries which have been subject to light use, end of life and failure condition, respectively. A non-degraded cell was included as a baseline. FIG. 9 is a plot of discharge capacity against cycle number for a Lithium ion cell. The levels to which (1) the baseline cell, (2) the light use cell, (3) the end-of-life cell and (4) the failure condition cell were discharged are shown on the plot. Charge/discharge performance tests were then carried out using a Lithium counter electrode to measure the capacity of the cathode electrode.

In phase two of the test, full cells were rebuilt with the used cathode and new anode, and capacity tests were performed on the rebuilt cells.

A capacity comparison between a refurbished aged cathode half-cell (90% capacity remaining) and a fresh cathode half-cell gave the following results:
Fresh cathode electrode half cell: 5.4 mAh
Aged cathode electrode half cell: 5.2 mAh

The aged cathode showed double layer impedance, implying SEI formation on the cathode. This resulted in a slight increase of the internal resistance of the aged cathode. However, the remaining capacity of the cathode is still comparable with that of a fresh cathode. This result implies that the material degradation of the cathode electrode is minimal, and that end-of-life of the cell is attributable primarily to anode degradation rather than cathode degradation.

The aged cathode was then used to make a full cell with a new anode, separator, and electrolyte. A capacity comparison between the refurbished full cells from aged and new cathodes gave the following results:
Fresh electrodes full cell: 5.4 mAh
Aged cathode+fresh anode full cell: 3.5 mAh

The capacity decrease of the aged cathode full cell (after the first charge) can be attributed to the consumption of Lithium ions in the previous life and new SEI formation (Lithium ions are consumed) of the newly rebuilt full cell.

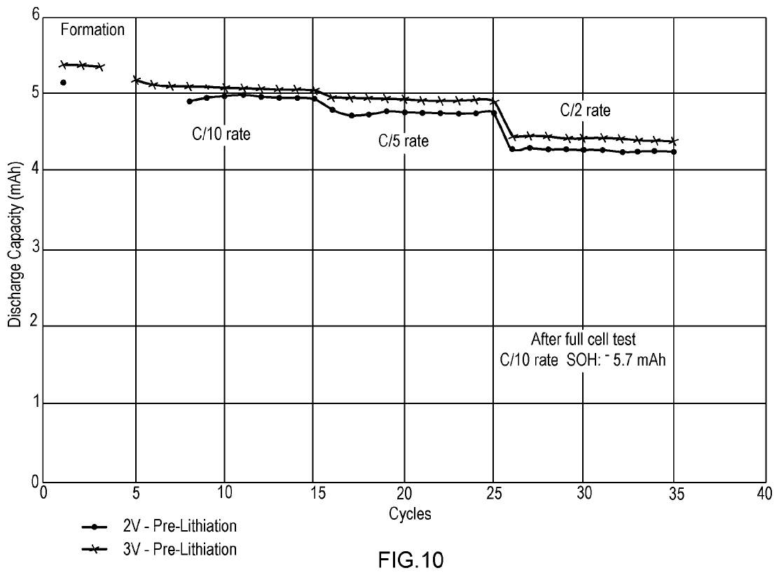

A re-lithiation process was then carried out on aged cathode modules. The re-lithiated cathode modules were incorporated into new full cells, and further tests carried out. FIG. 10 shows plots of discharge capacity against cycle number for the full cells with re-lithiated cathode modules. In this test, the full cells were charged and discharged at a rate of C/10 for the first 15 cycles, then at a rate of C/5 for the next ten cycles, then at a rate of C/2 for the subsequent ten cycles. The upper plot shows the results for full cells with cathode modules re-lithiated to 3V and the lower plot shows the results for full cells re-lithiated to 2V. The results show that re-lithiation of the cathode module can restore the capacity of the full rebuilt cell up to approximately 5.2 mAh. This is comparable to that of a new full cell and matches the half-cell test result of the aged cathode electrode noted above.

Thus, the test results show that a remanufacturing process that re-lithiates a used cathode module and combines the refurbished cathode module with a fresh anode module can create a battery cell with a capacity similar to that of a new cell. This process can help to reduce the overall energy expenditure, reduce the use of hazardous chemicals, reduce water consumption, reduce the use of raw materials and/or reduce CO2 emissions. Furthermore, the overall cost of ownership of a battery pack for an electric vehicle may be reduced.

The tests described above were carried out on an NMC Lithium ion battery. However, the techniques described herein can be applied to any type of Lithium ion-based battery cells.

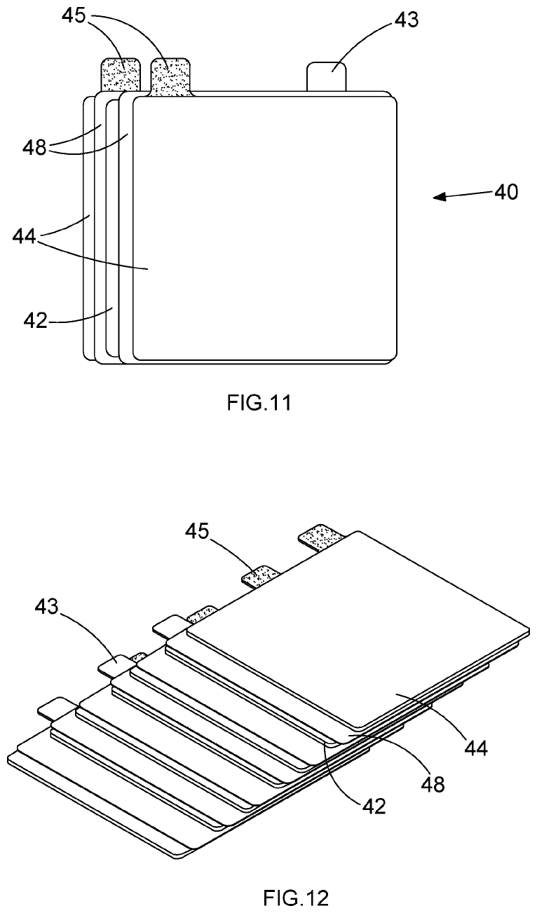

FIG. 11 shows parts of a battery cell in an embodiment of the invention. The battery cell in this embodiment is a “single layer” pouch cell comprising a cathode module and two anode modules.

Referring to FIG. 11, the battery cell 40 comprises a cathode module 42, two anode modules 44, and two separators 48. The cathode module 42 comprises an active layer on each side of a cathode current collector. The cathode current collector is connected to a terminal tab 43. The cathode module 42 may be a refurbished cathode module, which may have been refurbished using any of the techniques described above. Each of the anode modules 44 comprises a graphite layer on an anode current collector. The anode current collector is connected to a terminal tab 45. The anode module may be a newly manufactured anode module and may be in any of the forms described above.

In the arrangement of FIG. 11, the cathode module 42 is sandwiched between the two anode modules 44, with a separator 48 between the cathode module and each of the anode modules. The cathode module 42, anode modules 44 and separators 48 are packaged in a pouch (not shown) together with an electrolyte. The terminal tabs 43, 45 protrude through seals in the pouch, in order to allow external connections to be made with the cell. The two terminal tabs from the anode modules may be welded together. The pouch and the electrolyte may be newly manufactured, or refurbished, or any combination thereof.

FIG. 12 shows parts of a battery cell in a further embodiment of the invention. The battery cell in this embodiment is a “multi-layer” pouch cell comprising a plurality of cathode modules 42 and a plurality of anode modules 44. Each cathode module 42 is sandwiched between two anode modules 44, with a separator 48 between the two. As in the arrangement of FIG. 11, the cell components are packaged in a pouch. The terminal tabs protrude through seals in the pouch. The terminal tabs from the anode modules may be welded to each other. Likewise, the terminal tabs from the cathode modules may be welded to each other.

In an alternative arrangement, instead of or as well as re re-lithiating the cathode module, one or more anode modules may be pre-lithiated prior to constructing the new cell. In order to achieve this, the new anode module is assembled into a full cell with a separator, an organic electrolyte and lithium metal sheet as a Lithium ion source. The cell is then connected to an electrical potential and charged at a designated charging rate to a predetermined voltage. This causes the new anode module to undergo an electrochemical lithiation process. After the anode module has be lithiated to the required amount, it is dissembled from the cell and is incorporated into a new Lithium-ion cell in the manner described above. This may allow at least some of the ions lost from the cathode module during first life to be replaced.

It will be appreciated that embodiments of the present invention have been described above by way of example only, and modifications in detail will be apparent to the skilled person within the scope of the appended claims.

1. A method of manufacturing a battery cell, the method comprising:
recovering a cathode module from a used battery cell; and
assembling a new battery cell using the recovered cathode module.

2. The method of claim 1, wherein the whole of the recovered cathode module is used in the new battery cell.

3. The method of claim 1, wherein the used battery cell is from a battery pack which has failed or reached end-of-life.

4. The method of claim 1, wherein the new battery cell comprises the recovered cathode module and a new anode module.

5. The method of claim 1, wherein the new battery cell comprises a new electrolyte.

6. The method of claim 1, wherein the new battery cell comprises a new separator.

7. The method of claim 1, wherein the recovered cathode module comprises an active material and a current collector.

8. The method of claim 7, wherein the active material comprises a Lithium metal oxide.

9. (canceled)

10. The method of claim 7, wherein the current collector acts as a substrate for the active material and provides a path for current flow.

11. (canceled)

12. (canceled)

13. The method of claim 1, further comprising performing a re-lithiation process on the recovered cathode module prior to assembling the new battery cell.

14. The method of claim 13, wherein the re-lithiation process is an electrochemical process.

15. The method of 14, wherein, during the electrochemical re-lithiation process, the recovered cathode module is used as an electrode.

16. The method of claim 13, wherein the re-lithiation process is performed using a full cell in which the recovered cathode module is used as a negative electrode, the full cell further comprising a positive electrode comprising Lithium.

17. The method of claim 13, wherein the re-lithiation process comprises chemical immersion with a Lithium electrolyte.

18. The method of claim 1, further comprising performing a pre-lithiation process an anode module prior to assembling the new battery cell.

19. (canceled)

20. The method of claim 1, further comprising packaging the new battery cell in a container.

21. A battery cell comprising:
a cathode module recovered from a used battery cell;
a new anode module; and
new electrolyte.

22. The battery cell of claim 21, wherein the cathode module is re-lithiated.

23. The battery cell of claim 21, further comprising a new separator.

24. The battery cell of claim 21, wherein the battery cell is packaged in a container.

25. (canceled)
